(19) United States
(12) Patent Application Publication
(10) Pub. No.: US 2026/0279647 A1
(43) Pub. Date: Sep. 17, 2026

(54) COIL STRUCTURE AND MANUFACTURING METHOD THEREFOR

(71) Applicants: TRITYPE ELECTRIC CO., LTD., Kaiping City, Jiangmen (CN); HAIHONG ELECTRIC CO., LTD., Kaiping City, Jiangmen (CN)

(72) Inventors: Kaixuan XU, Kaiping City, Jiangmen (CN); Qingning LIANG, Kaiping City, Jiangmen (CN); Yuxiang QI, Kaiping City, Jiangmen (CN); Danju SONG, Kaiping City, Jiangmen (CN); Fei LI, Kaiping City, Jiangmen (CN); Wenjie FANG, Kaiping City, Jiangmen (CN); Huilin GUAN, Kaiping City, Jiangmen (CN); Yucheng ZHOU, Kaiping City, Jiangmen (CN); Xueming ZHANG, Kaiping City, Jiangmen (CN); Huaming WANG, Kaiping City, Jiangmen (CN); Weifeng TAN, Kaiping City, Jiangmen (CN); Quanan XU, Kaiping City, Jiangmen (CN)

(21) Appl. No.: 19/469,449

(22) PCT Filed: May 29, 2023
(86) PCT No.: PCT/CN2023/096817

§ 371 Date: Sep. 26, 2025

(30) Foreign Application Priority Data
May 15, 2023 (CN) 202310548525.8

(51) Int. Cl. H01F 27/28; H01F 27/24; H01F 41/06

(52) U.S. Cl. CPC H01F 27/28; H01F 27/24; H01F 41/06

(57) ABSTRACT

The present application relates to a new type coil structure and a manufacturing method therefor. The new type coil structure comprises an inner coil, an insulating cylinder layer, an outer coil, and first angular rings, wherein the inner coil is arranged at an inner side of the insulating cylinder layer in a surrounding manner; the outer coil is arranged at an outer side of the insulating cylinder layer in a surrounding manner; and two first angular rings are provided in such a way that annular structures are formed by means of insulating tapes being wound around the two first angular rings and the two first angular rings are respectively positioned at two ends of the outer coil. By means of the first angular rings being respectively arranged at the two ends of the outer coil, the electric field intensity at the end portions of the outer coil can be reduced, such that the electric insulation performance of the new type coil structure is improved. In addition, since the first angular rings are directly formed by means of winding the insulating tapes, the phenomenon of a reduction in the insulation performance of the first angular rings due to same prone to being dampened is avoided, such that the overall electrical insulation performance of the new type coil structure is relatively stable, and the reliability of the insulation performance is thus higher.

### CROSS REFERENCE TO RELATED APPLICATIONS

This application is a U.S. National Phase application under 35 U.S.C. § 371 of International Application No. PCT/CN2023/096817, filed on May 29, 2023, and claims benefit to Chinese Patent Application No. CN202310548525.8, filed on May 15, 2023. The International Application was published in Chinese on Nov. 21, 2024 as WO 2024/234412 A1 under PCT Article 21(2).

### FIELD

The present disclosure relates to the field of transformers, and to a coil structure and a manufacturing method therefor.

### BACKGROUND

In recent years, with the acceleration of urbanization process and the rapid development of industries such as rail transit and data centers in China, the demand for fire-proof and explosion-proof dry-type transformers has also been steadily increasing year by year. Closed solid wound core dry-type transformers are widely used due to their advantages of low noise, low radiation, fire-proof and explosion-proof.

For a closed solid wound core dry-type transformer with voltage levels of 20 kV and above, because the field strength at the coil end is relatively large, in order to ensure the electrical insulating performance of the product, an air distance between an outer coil and an inner coil, as well as metal components such as an upper iron yoke and a lower iron yoke of the core, is increased to meet an electrical insulating performance requirement of this type of transformer. However, the increased air insulation distance enlarges the components such as the core and coil, which is not conducive to the transportation and installation of the transformer. A crepe paper soft corner ring may be directly arranged at the end of the coil in order to meet the requirements of volume and insulating performance at the same time. However, because the crepe paper is made of insulating kraft paper by crinkling processing, the present inventors have recognized that with the increase of the service life of the dry-type transformer, the corner ring made of the crepe paper is easily affected by moisture, the electrical insulating performance is decreased, thereby reducing the reliability of the dry-type transformer.

### SUMMARY

Aspects of the present disclosure provide a coil structure and a manufacturing method therefor to address at least the above-described problems in the field. Advantageously, a coil implemented according to the present disclosure has high insulation reliability and strong stability.

According to one aspect of the present disclosure, there is provided a coil structure that includes: an inner coil, an insulating cylindrical layer, an outer coil, and two first corner rings. The inner coil is arranged around an inner side of the insulating cylindrical layer, and the outer coil is arranged around an outer side of the insulating cylindrical layer. Each of the two first corner rings is wrapped with an insulating tape to form a ring structure, and the two first corner rings are located at both ends of the outer coil, respectively.

In the above coil structure, the electric field strength at the end of the outer coil can be reduced by the first corner rings at both ends of the outer coil, thereby improving the electrical insulating performance of the coil structure. In addition, the first corner ring can be directly formed by wrapping the insulating tape, which results in the phenomenon that the insulating performance of the first corner ring is reduced by avoiding moisture, making the overall electrical insulating performance of the coil structure stable and enhancing the insulating performance reliability.

In an embodiment, the coil structure further includes a plurality of comb-shaped stays arranged on the outer side of the insulating cylindrical layer along a circumferential direction of the insulating cylindrical layer. Both ends of each of the plurality of comb-shaped stays have a corner ring slot, and two corner ring slots are respectively configured to clamp with the two first corner rings in a one-to-one corresponding manner. Each of the plurality of comb-shaped stays has a plurality of comb tooth notches along an axial direction thereof, and each of the plurality of comb tooth notches is located between the two corner ring slots. The outer coil includes a plurality of wire cakes arranged in a stacked manner, and the plurality of wire cakes correspond one-to-one to the plurality of comb tooth notches, and each of the wire cakes is clamped in the corresponding comb tooth notch, respectively.

In an embodiment, each of the plurality of comb-shaped stays includes a first stay portion and a second stay portion. A mounting groove is formed in the first stay portion. The second stay portion is arranged in the mounting groove, and spaced apart from a groove wall of the mounting groove to form the two corner ring slots. The plurality of comb tooth notches are spaced apart along an axial direction of the second stay portion on one side of the second stay portion facing away from the first stay portion.

In an embodiment, each of the first corner rings includes a first cylinder and a first extension ring. One end of the first cylinder is connected to an inner ring of the first extension ring to form an included angle. Each of the two corner ring slots includes a first slot body and a second slot body that are in communication to form an included angle. The first cylinder is clamped in each of the plurality of first slot bodies, and the first extension ring is clamped in each of the plurality of second slot bodies to cover an end surface of the outer coil.

In an embodiment, the coil structure further includes a corner ring support assembly which includes a first limiting cylinder, a second limiting cylinder, and a support ring. The first limiting cylinder and the second limiting cylinder are both arranged in each the plurality of first slot bodies. The first limiting cylinder abuts against one side of the first cylinder, and the second limiting cylinder abuts against the other side of the first cylinder. The support ring is arranged in each of the plurality of second slot bodies, and supported on one side of the first extension ring facing towards the first cylinder.

In an embodiment, the coil structure further includes a plurality of wire cake end rings. Each of the plurality of comb-shaped stays has a plurality of end ring slots along an axial direction thereof, and each of the plurality of end ring slots is located between the two corner ring slots. The plurality of wire cake end rings are clamped in a one-to-one correspondence with the plurality of end ring slots, respectively.

Additionally or alternately, the coil structure further includes a second corner ring which includes a second cylinder and a second extension ring. One end of the second cylinder is connected to an inner ring of the second extension ring to form an included angle. The insulating cylinder layer includes an inner insulating cylinder and an outer insulating cylinder that are in a sleeving manner. The inner coil is arranged around an inner side of the inner insulating cylinder, and each of the plurality of comb-shaped stays is arranged on an outer side of the outer insulating cylinder. The second cylinder is inserted between the inner insulating cylinder and the outer insulating cylinder, and the second extension ring extends towards a direction close to each of the plurality of comb-shaped stays to cover an end surface of each of the plurality of comb-shaped stays.

Additionally or alternately, the coil structure further includes two end retaining rings. Both ends of each of the plurality of comb-shaped stays have a retaining ring slot, respectively. The plurality of retaining ring slots are farther away from the plurality of comb tooth notches than the plurality of corner ring slots. The two retaining ring slots are respectively clamped to the two end retaining rings in a one-to-one correspondence manner.

The present disclosure further provides a manufacturing method for a coil structure, which includes the following steps: winding a first wire into an inner coil; assembling an insulating cylindrical layer outside the inner coil; spacing apart each of a plurality of comb-shaped stays along a circumferential direction of the insulating cylindrical layer on an outer side of the insulating cylindrical layer, and wrapping and folding an outer side of each of the plurality of comb-shaped stays with an insulating tape to form first corner rings; winding an outer coil on an outer side of each of the plurality of comb-shaped stays; and mounting a wire cake end ring and an end retaining ring on each of the plurality of comb-shaped stays.

In an embodiment, assembling the insulating cylindrical layer on an outer side of the inner coil includes: splicing two prefabricated inner semi-cylinders outside the inner coil to form an inner insulating cylinder; winding at least one inner insulating layer on an outer wall of the inner insulating cylinder, and staggering a joint of the inner insulating layer and a joint of the inner insulating cylinder; splicing two prefabricated outer semi-cylinders outside the inner insulating layer to form an outer insulating cylinder; and winding at least one outer insulating layer on an outer wall of the outer insulating cylinder, and staggering a joint of the outer insulating layer and a joint of the outer insulating cylinder.

In an embodiment, the manufacturing method for a coil structure further includes: winding an insulating tape between the inner insulating layer and the outer insulating cylinder to form a second annular tape layer, and turning one end of the second annular tape layer outward so that a turned-out portion covers an end surface of the outer insulating cylinder to form a second corner ring.

In an embodiment, spacing apart the plurality of comb-shaped stays along the circumferential direction of the insulating cylindrical layer on the outer side of the insulating cylindrical layer, and wrapping and folding the outer side of each of the plurality of comb-shaped stays with the insulating tape to form first corner rings includes: forming a first stay portion and a second stay portion in each of the plurality of comb-shaped stays, where a mounting groove is formed in the first stay portion, the second stay portion is arranged in the mounting groove, and spaced apart from the groove wall of the mounting groove to form an corner ring slot; spacing apart the first stay portions along a circumferential direction of the insulating cylindrical layer on the outer side of the insulating cylindrical layer; winding a first limiting cylinder around each of the plurality of first stay portions; wrapping an insulating tape around the first limiting cylinder to form a first annular tape layer; winding a second limiting cylinder on an outer side of the first annular tape layer; assembling a plurality of prefabricated arc-shaped rings on the outer side of the first annular tape layer to form a circular support ring, turning one end of the first annular tape layer outward and laying a turned-out portion on the support ring in a radial direction of the support ring to form a first corner ring; and arranging the second stay portion in the corresponding first stay portion to form the corner ring slot, and clamping the first corner ring in the corner ring slot.

### BRIEF DESCRIPTION OF DRAWINGS

The drawings that constitute a part of the present disclosure are used to enhance understanding of the present disclosure. The illustrative embodiments of the present disclosure and descriptions thereof are used to explain the present disclosure and should not be construed as necessarily limiting the scope of the disclosure.

In addition, the drawings are not drawn at 1:1 scale, and the relative sizes of various elements are drawn only as examples in the drawings and are not necessarily drawn according to true scale. In the drawings:

FIG. 1 is a schematic structural diagram of a coil structure and a winding mold according to an embodiment of the present disclosure.

FIG. 2 is a schematic structural diagram of a coil structure wound on a core according to an embodiment of the present disclosure.

FIG. 3 is a perspective view of a coil structure according to an embodiment of the present disclosure.

FIG. 4 is a cross-sectional view of a coil structure according to a first embodiment of the present disclosure.

FIG. 5 is a cross-sectional view of a coil structure according to another embodiment of the present disclosure.

FIG. 6 is a schematic structural diagram of a comb-shaped stay in the coil structure in FIG. 3.

FIG. 7 is an exploded schematic structural diagram of the comb-shaped stay in FIG. 6.

FIG. 8 is a schematic structural diagram of a first corner ring in the coil structure illustrated in FIG. 3.

FIG. 9 is a structural sectional view of a first corner ring and a corner ring support assembly according to an embodiment of the present disclosure.

### DETAILED DESCRIPTION

For further elaboration regarding features and advantages of the present disclosure, exemplary implementation of the present disclosure are described below with reference to the accompanying drawings. In the following description, numerous example details are set forth in order to provide a thorough understanding of the present disclosure. However, the present disclosure can be implemented in many other ways than those described herein, and those skilled in the art can make similar improvements without violating the connotation of the present disclosure. Therefore, the present disclosure is not limited to the example embodiments discussed below.

In the description of the present disclosure, it should be understood that if the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, and the like appear, the orientation or position relationship indicated by these terms is based on the orientation or position relationship shown in the accompanying drawings, which is only for the convenience of describing the present disclosure and simplifying the description, rather than indicating or implying that the device or element referred to must have a specific orientation, be constructed and operated in a specific orientation, and therefore cannot be understood as a limitation on the present disclosure.

In addition, the terms “first” and “second” are used for descriptive purposes only and should not be understood as indicating or implying relative importance or implicitly indicating the quantity of the technical features indicated. Therefore, features defined as “first” or “second” may explicitly or implicitly include at least one of the features. In the description of the present disclosure, the term “plurality of” means at least two, such as two, three, and the like, unless otherwise clearly defined.

In the present disclosure, unless otherwise clearly specified or limited, if the terms “mount”, “connect”, “connection”, “fix” and the like appear, these terms should be understood in a broad sense. For example, it can be fixedly connected, detachably connected, or integrated; can be mechanically connected or electrically connected; can be directly connected or indirectly connected through an intermediate medium, and can be internal communication between two elements or interaction relationship between two elements, unless otherwise clearly defined. For those skilled in the art, the specific meanings of the above terms in the present disclosure can be understood according to specific circumstances.

In the present disclosure, unless otherwise clearly specified and limited, if there is a description that a first feature is “on” or “under” a second feature, and the like, it may mean that the first and second features are in direct contact, or the first and second features are in indirect contact through an intermediate medium. Moreover, the first feature being “on the top”, “above” and “on” the second feature may mean that the first feature is directly above or obliquely above the second feature, or simply means that the first feature is horizontally higher than the second feature. The first feature being “under”, “below”, and “beneath” the second feature may mean that the first feature is directly below or obliquely below the second feature, or simply means that the first feature is at a smaller horizontal height than the second feature.

It should be noted that, if an element is referred to as being “fixed on” or “arranged on” another element, it may be directly on the other element or there may be an element located in the middle. If an element is referred to as being “connected to” another element, it can be directly connected to the other element or there may be an element located in the middle at the same time. The terms “vertical”, “horizontal”, “upper”, “lower”, “left”, “right” and similar expressions used in the present disclosure are for illustrative purposes only and do not represent the only implementation method.

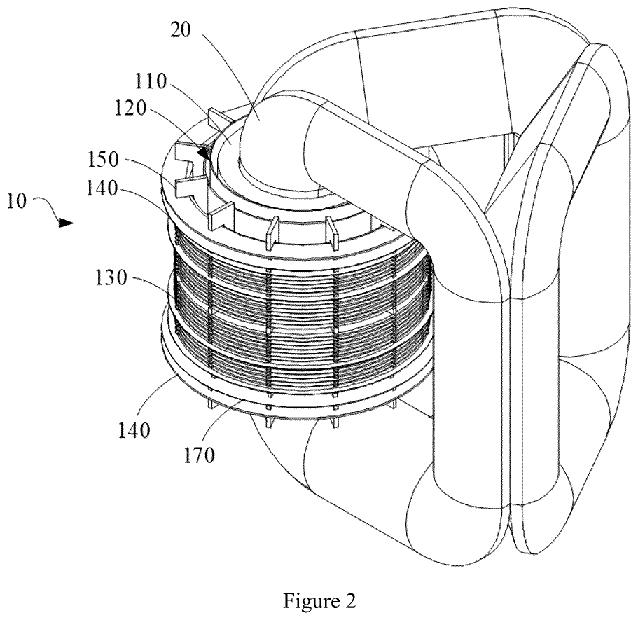

Referring to FIG. 2 to FIG. 4, an embodiment of the present disclosure provides a coil structure 10, including: an inner coil 110, an insulating cylindrical layer 120, an outer coil 130, and two first corner rings 140. The inner coil 110 is arranged around an inner side of the insulating cylindrical layer 120, and the outer coil 130 is arranged around an outer side of the insulating cylindrical layer 120. Each of the two first corner rings 140 is wrapped with an insulating tape to form a ring structure, and the two first corner rings 140 are located at both ends of the outer coil 130, respectively.

In the coil structure 10, the electric field strength at the ends of the outer coil 130 can be reduced by the first corner rings 140 at both ends of the outer coil 130, thereby improving the electrical insulating performance of the coil structure 10. In addition, because the first corner ring 140 is directly formed by wrapping the insulating tape, a phenomenon that the insulating performance of the first corner ring 140 is reduced by avoiding moisture. Therefore, the overall electrical insulating performance of the coil structure 10 is stable and the insulating performance reliability is high.

It should be noted that the insulating tape referred to in this embodiment has strong electrical performance, high density, good ductility, and so on. Because the insulating tape is easy to clean and not prone to dust accumulation, the insulating performance of the first corner ring 140 is relatively stable.

Referring to FIG. 2 to FIG. 4 and FIG. 6, in an embodiment, the coil structure 10 further includes a plurality of comb-shaped stays 150 arranged on the outer side of the insulating cylindrical layer 120 along a circumferential direction of the insulating cylindrical layer 120. Both ends of each of the plurality of comb-shaped stays 150 have a corner ring slot 153, and two corner ring slots 153 are respectively configured to clamp with the two first corner rings 140 in a one-to-one corresponding manner.

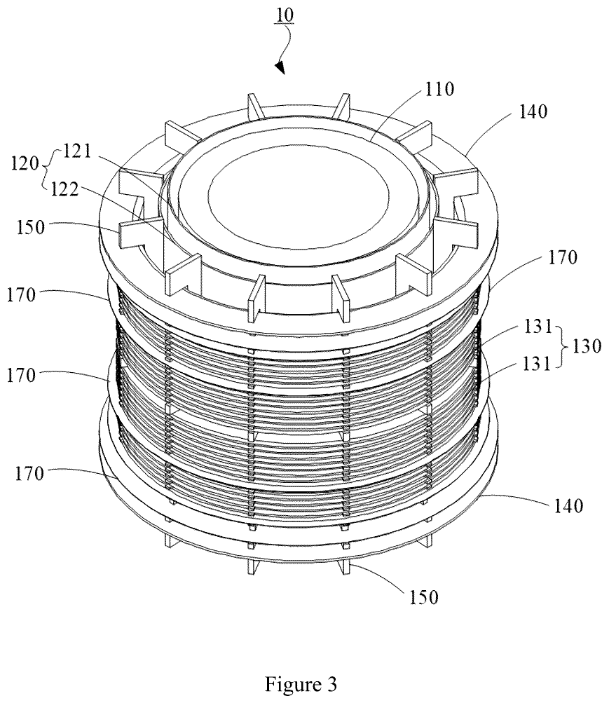

For example, as shown in FIG. 3 to FIG. 7, each of the plurality of comb-shaped stays 150 has a plurality of comb tooth notches 1521 along an axial direction thereof, and each of the plurality of comb tooth notches 1521 is located between the two corner ring slots 153. The outer coil 130 includes a plurality of wire cakes 131 arranged in a stacked manner, and the plurality of wire cakes 131 correspond one-to-one to the plurality of comb tooth notches 1521, and each of the wire cakes 131 is clamped in the corresponding comb tooth notch 1521, respectively. The plurality of comb-shaped stays 150 can effectively support the outer coil 130 and the first corner rings 140, while improving the simplicity of the coil structure 10.

It should be noted that, in this embodiment, the plurality of comb-shaped stays 150 are made of an insulating material.

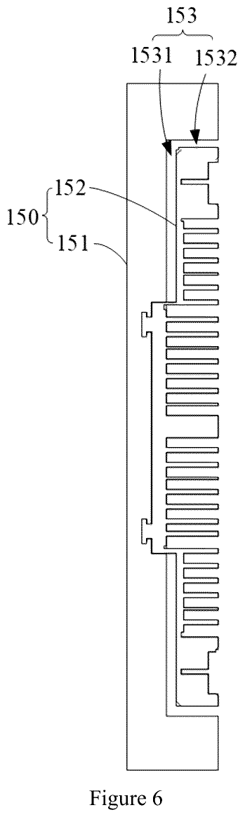

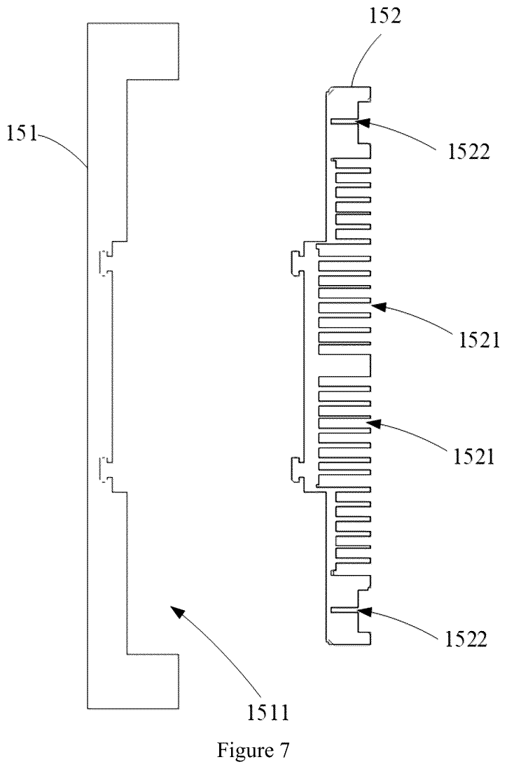

Referring to FIG. 6 and FIG. 7, in an embodiment, each of the plurality of comb-shaped stays 150 includes a first stay portion 151 and a second stay portion 152. A mounting groove 1511 is formed in the first stay portion 151. The second stay portion 152 is arranged in the mounting groove 1511, and spaced apart from a groove wall of the mounting groove 1511 to form the corner ring slot 153. The plurality of comb tooth notches 1521 are spaced apart along an axial direction of the second stay portion 152 on one side of the second stay portion 152 facing away from the first stay portion 151. In this way, it is convenient to wind the wire cake 131 in each comb tooth notch 1521 to form the outer coil 130.

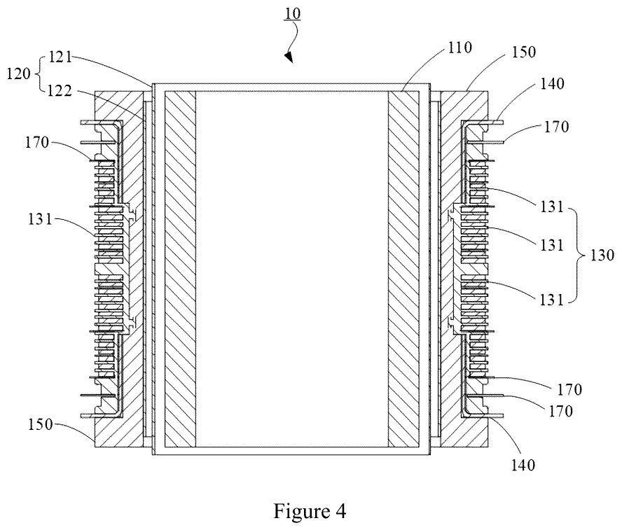

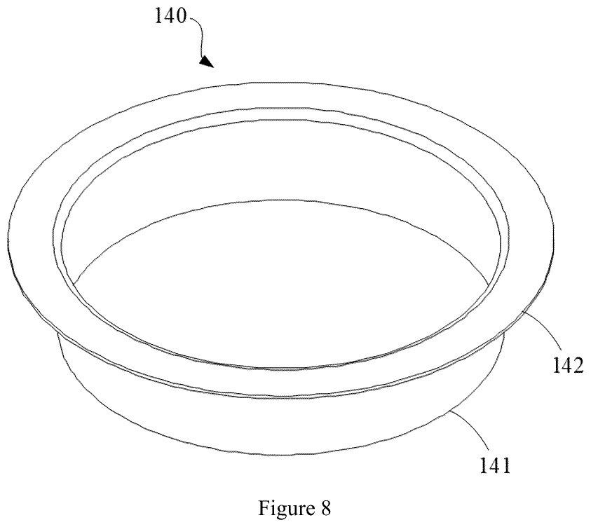

Referring to FIG. 4 and FIG. 8, in an embodiment, each of the first corner rings 140 includes a first cylinder 141 and a first extension ring 142. One end of the first cylinder 141 is connected to an inner ring of the first extension ring 142 to form an included angle. Each of the corner ring slots 153 includes a first slot body 1531 and a second slot body 1532 that are connected with each other to form an included angle. The first cylinder 141 is clamped in each of the first slot bodies 1531, and the first extension ring 142 is clamped in each of the second slot bodies 1532 and covers an end surface of the outer coil 130.

In order to enable the first corner ring 140 to be mounted into the mounting groove 1511 or removed from the mounting groove 1511, in this embodiment, as shown in FIG. 6 and FIG. 7, the second stay portion 152 is detachably arranged in the mounting groove 1511.

It should be noted that, in this embodiment, the insulating tape is a thin silicone tape, which has excellent electrical performance, high density, good ductility and so on. Because the first corner ring 140 is wound with the insulating tape to form the first annular tape layer of an annular structure, the first cylinder 141 and the first extension ring 142 that are connected at an included angle can be formed by turning outward one end of the first annular tape layer.

It should be noted that the first annular tape layer includes at least one layer of the annular tape wound by a thin silicone tape. A joint of two adjacent layers of the annular tapes is staggered.

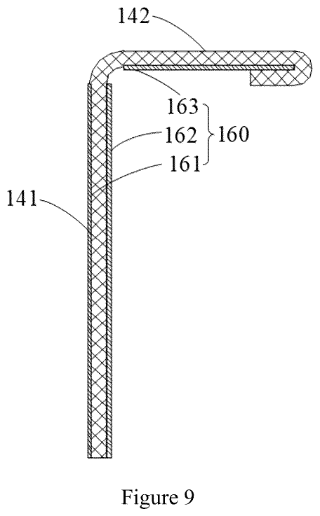

Referring to FIG. 4 to FIG. 9, in order to prevent the insulating tape from being deformed when it is wound on each of the comb-shaped stays 150 and affecting the insulating effect of each of the plurality of first corner rings 140, in an embodiment, the coil structure 10 further includes a corner ring support assembly 160. The corner ring support assembly 160 includes a first limiting cylinder 161, a second limiting cylinder 162, and a support ring 163. The first limiting cylinder 161 and the second limiting cylinder 162 are both arranged in the first slot body 1531, the first limiting cylinder 161 abuts against one side of the first cylinder 141 and the second limiting cylinder 162 abuts against the other side of the first cylinder 141. The support ring 163 is arranged in the second slot body 1532 to support on one side of the first extension ring 142 facing the first cylinder 141.

Referring to FIG. 2 to FIG. 5, in order to further improve the electric field strength at both ends of the outer coil 130 and enhance the insulating performance of the coil structure 10, in an embodiment, the coil structure 10 further includes a plurality of wire cake end rings 170. Each of the comb-shaped stays 150 has a plurality of end ring slots 1522 along an axial direction thereof, and each of the plurality of end ring slots 1522 is located between the two corner ring slots 153. The plurality of wire cake end rings 170 are clamped with the plurality of end ring slots 1522 in a one-to-one correspondence manner, respectively.

In an embodiment, the plurality of wire cake end rings 170 may be located between the plurality of wire cakes 131. Alternatively, the plurality of wire cake end rings 170 are respectively located at both ends of the outer coil 130. Alternatively, some of the plurality of wire cake end rings 170 are located between the wire cakes 131, and some of the plurality of wire cake end rings 170 are located at both ends of the outer coil 130.

For example, in this embodiment, each end of the outer coil 130 has a wire cake end ring 170, and at least one wire cake end ring 170 is arranged between the plurality of wire cakes 131.

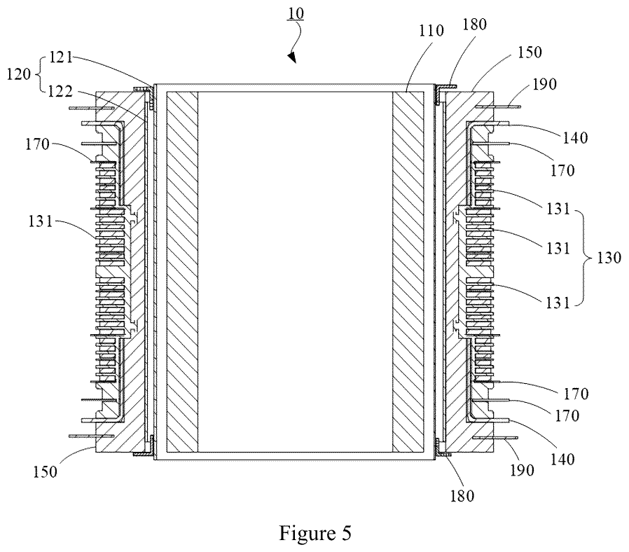

Referring to FIG. 5, in another embodiment, the coil structure 10 further includes a second corner ring 180. The second corner ring 180 includes a second cylinder and a second extension ring. One end of the second cylinder is connected to an inner ring of the second extension ring to form an included angle. The insulating cylinder layer 120 includes an inner insulating cylinder 121 and an outer insulating cylinder 122 that are sleeved. The inner coil 110 is arranged around an inner side of the inner insulating cylinder, each of plurality of the comb-shaped stays 150 is arranged on an outer side of the outer insulating cylinder 122. The second cylinder is inserted between the inner insulating cylinder 121 and the outer insulating cylinder 122. The second extension ring extends toward each of the plurality of comb-shaped stays 150 and covers an end surface of each of plurality of the comb-shaped stays 150.

For example, two second corner rings 180 are respectively located at both ends of the insulating cylindrical layer 120. In this way, the electric field strength at both ends of the outer coil 130 can be further improved, thereby enhancing the insulating performance of the coil structure 10.

Referring to FIG. 5 to FIG. 7 again, in an embodiment, the coil structure 10 further includes two end retaining rings 190. Both ends of each of plurality of the comb-shaped stays 150 have a retaining ring slot, respectively. The retaining ring slot is farther away from the comb tooth notch 1521 than the corner ring slots 153. Two retaining ring slots are respectively connected to the two end retaining rings 190 in a one-to-one correspondence manner. In this way, a creepage distance between the outer coil 130 and the iron yoke of the core 20 can be further increased, thereby improving the insulating performance of the coil structure 10.

It should be noted that the wire cake end ring 170 and the end retaining ring 190 are both made of an insulating material.

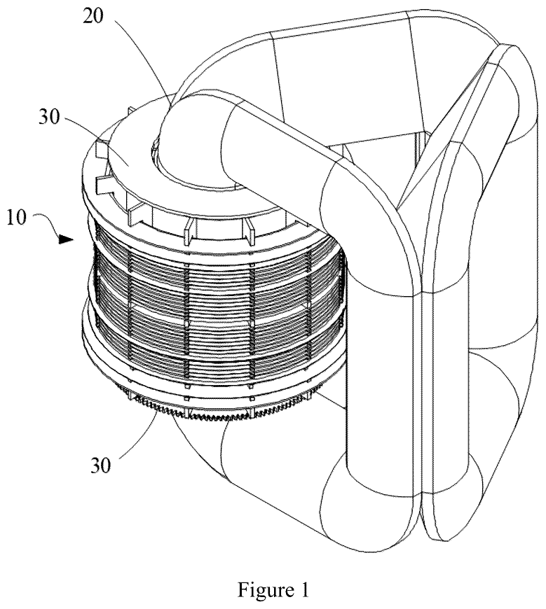

Referring to FIG. 1 to FIG. 4, an embodiment of the present disclosure further provides a manufacturing method for a coil structure 10, including:
winding a first wire into an inner coil 110;
assembling an insulating cylindrical layer 120 on an outer side of the inner coil 110;
spacing apart a plurality of comb-shaped stays 150 along a circumferential direction of the insulating cylindrical layer 120 on an outer side of the insulating cylindrical layer 120, and wrapping and folding an insulating tape on an outer side of each of the plurality of comb-shaped stays 150 to form a plurality of first corner rings 140;
winding a second wire into an outer coil 130 on an outer side of each of the plurality of comb-shaped stays; and
mounting a wire cake end ring 170 and an end retaining ring 190 on each of the plurality of comb-shaped stays 150.

In an embodiment, as shown in FIG. 1 to FIG. 4, before winding the first wire into the inner coil 110, the manufacturing method further includes a following step: mounting a winding mold 30 on a core column of the core 20. The wound inner coil 110 is supported by the winding mold 30.

In an embodiment, assembling the insulating cylindrical layer 120 on an outer side of the inner coil 110 includes:
splicing two prefabricated inner semi-cylinders outside the inner coil 110 to form an inner insulating cylinder 121;
winding at least one inner insulating layer on an outer wall of the inner insulating cylinder 121, and staggering a joint of the inner insulating layer and a joint of the inner insulating cylinder 121;
splicing two prefabricated outer semi-cylinders outside the inner insulating layer to form an outer insulating cylinder 122; and
winding at least one outer insulating layer on an outer wall of the outer insulating cylinder 122, and staggering a joint of the outer insulating layer and a joint of the outer insulating cylinder 122.

The reliability of the insulation between the outer coil 130 and the inner coil 110 can be improved by winding the inner insulating layer on the inner insulating cylinder 121 and the outer insulating layer on the outer insulating cylinder 122. The method of staggering the joint of the inner insulating layer and the joint of the inner insulating tube 121, and staggering the joint of the outer insulating layer and the joint of the outer insulating tube 122 can effectively reduce the risk of leakage breakdown from gaps or joints in the coil structure 10, thereby ensuring that the coil structure 10 has good insulating performance.

It should be noted that if a plurality of inner insulating layers or outer insulating layers are arranged, the joints between two adjacent layers are staggered.

It should be noted that the two inner semi-cylinders are bonded and spliced together by insulating glue to form the inner insulating cylinder 121, and the two outer semi-cylinders are bonded and spliced together by insulating glue to form the outer insulating cylinder 122.

In an embodiment, as shown in FIG. 5, the manufacturing method for a coil structure 10 further includes: winding an insulating tape between the inner insulating layer and the outer insulating cylinder 122 to form a second annular tape layer, and turning one end of the second annular tape layer outward so that a turned-out portion covers an end surface of the outer insulating cylinder 122 to form a second corner ring 180.

Referring to FIG. 2 to FIG. 9, in an embodiment, spacing apart the plurality of comb-shaped stays 150 along a circumferential direction of the insulating cylindrical layer 120 on the outer side of the insulating cylindrical layer 120, and wrapping and folding the insulating tape on the outer side of each of the plurality of comb-shaped stays 150s to form the plurality of first corner rings 140 includes:
forming a first stay portion 151 and a second stay portion 152 in each of the plurality of comb-shaped stays 150, where a mounting groove 1511 is formed in the first stay portion 151, the second stay portion 152 is arranged in the mounting groove 1511, and spaced apart from a groove wall of the mounting groove 1511 to form a corner ring slot 153;
spacing apart the first stay portions 151 along a circumferential direction of the insulating cylindrical layer 120 on the outer side of the insulating cylindrical layer 120;
winding a first limiting cylinder 161 around each of the plurality of first stay portions 151;
wrapping an insulating tape around the first limiting cylinder 161 to form a first annular tape layer;
winding a second limiting cylinder 162 on an outer side of the first annular tape layer;
assembling a plurality of prefabricated arc-shaped rings on the outer side of the first annular tape layer to form a circular support ring 163, turning one end of the first annular tape layer outward and laying the turned-out portion on the support ring 163 in a radial direction of the support ring 163 to form a first corner ring 140; and
arranging the second stay portion 152 in the corresponding first stay portion 151 to form the corner ring slot 153, and clamping the first corner ring 140 in the corner ring slot 153.

In an embodiment, turning one end of the first annular tape layer outward and laying the turned-out portion on the support ring 163 in a radial direction of the support ring 163 to form a first corner ring 140 further includes:
turning outward one end of the first annular tape layer and laying the turned-out portion on the support ring 163 in the radial direction of the support ring 163; and
stretching the turned-out portion to an outer ring of the support ring 163, and enabling the turned-out portion to cover the outer ring of the support ring 163 to form the first corner ring 140.

In an embodiment, after the wire cake end ring 170 and the end retaining ring 190 are mounted on each of the plurality of comb-shaped stays 150, the manufacturing method further includes a following step: removing the winding mold 30, and performing varnish impregnation and drying on the wound coil structure 10.

The technical features of the above embodiments can be combined arbitrarily. In order to make the description concise, not all possible combinations of the technical features in the above embodiments are described. However, as long as there is no contradiction in the combination of these technical features, they should be considered to be within the scope of this specification.

The above embodiments only express several implementation methods of the present disclosure. The descriptions thereof are relatively specific and detailed, but they should not be understood as limiting the scope of the patent application. It should be noted that those having ordinary skill in the art can make several variations and improvements without departing from the concept of the present disclosure, and these all fall within the scope of protection of the present disclosure. Therefore, the scope of protection of this patent application should be based on the appended claims.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above. The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### Reference Numerals

10, coil structure;
110, inner coil;
120, insulating cylindrical layer;
121, inner insulating cylinder;
122, outer insulating cylinder;
130, outer coil;
131, wire cake;
140, first corner ring;
141, first cylinder;
142, first extension ring;
150, comb-shaped stay;
151, first stay portion;
1511, mounting groove;
152, second stay portion;
1521, comb tooth notch;
1522, end ring slot;
153, corner ring slot;
1531, first slot body;
1532, second slot body;
160, corner ring support assembly;
161, first limiting cylinder;
162, second limiting cylinder;
163, support ring;
170, wire cake end ring;
180, second corner ring;
190, end retaining ring;
20, core;
30, winding mold.

1. A coil structure, comprising:
an insulating cylindrical layer;
an inner coil arranged around an inner side of the insulating cylindrical layer;
an outer coil arranged around an outer side of the insulating cylindrical layer; and
two first corner rings located at both ends of the outer coil respectively,
wherein each of the two first corner rings is wrapped with an insulating tape to form a ring structure.

2. The coil structure according to claim 1, further comprising:
a plurality of comb-shaped stays arranged on the outer side of the insulating cylindrical layer along a circumferential direction of the insulating cylindrical layer,
wherein both ends of each of the plurality of comb-shaped stays have a corner ring slot, respectively, and two corner ring slots are respectively configured to clamp with the two first corner rings in a one-to-one corresponding manner,
wherein each of plurality of the comb-shaped stays has a plurality of comb tooth notches along an axial direction of the each of plurality of the comb-shaped stays, and each of the plurality of comb tooth notches is located between the two corner ring slots, and
wherein the outer coil comprises a plurality of wire cakes arranged in a stacked manner which correspond one-to-one to the plurality of comb tooth notches, and each of the plurality of wire cakes is clamped in the corresponding comb tooth notch, respectively.

3. The coil structure according to claim 2,
wherein each of the plurality of comb-shaped stays comprises a first stay portion in which a mounting groove is formed, and a second stay portion arranged in the mounting groove and spaced apart from a groove wall of the mounting groove to form the two corner ring slots, and
wherein the plurality of comb tooth notches are spaced apart along an axial direction of the second stay portion on one side of the second stay portion facing away from the first stay portion.

4. The coil structure according to claim 3,
wherein each of the two first corner rings comprises a first cylinder and a first extension ring,
wherein one end of the first cylinder is connected to an inner ring of the first extension ring to form an included angle,
wherein each of the two corner ring slots comprises a first slot body and a second slot body that are in communication to form the included angle,
wherein the first cylinder is clamped in each of the plurality of first slot bodies, and
wherein the first extension ring is clamped in each of the plurality of second slot bodies to cover an end surface of the outer coil.

5. The coil structure according to claim 4, further comprising a corner ring support assembly, which comprises:
a first limiting cylinder and a second limiting cylinder, which are both arranged in each of the plurality of first slot bodies in such way that the first limiting cylinder abuts against one side of the first cylinder and the second limiting cylinder abuts against the other side of the first cylinder; and
a support ring arranged in each of the plurality of second slot bodies and supported on one side of the first extension ring facing towards the first cylinder.

6. The coil structure according to claim 2, further comprising a plurality of wire cake end rings,
wherein each of the plurality of comb-shaped stays has a plurality of end ring slots along the axial direction of the each of the plurality of comb-shaped stays, and each of the plurality of end ring slots is located between the two corner ring slots, such that the plurality of wire cake end rings are clamped in a one-to-one correspondence with the plurality of end ring slots, respectively.

7. A method for manufacturing coil structure, the method comprising:
winding a wire into an inner coil;
assembling an insulating cylindrical layer on an outer side of the inner coil;
spacing apart a plurality of comb-shaped stays along a circumferential direction of the insulating cylindrical layer on an outer side of the insulating cylindrical layer, and wrapping and folding an insulating tape on an outer side of each of the plurality of comb-shaped stays to form a first corner ring;
winding an outer coil on an outer side of each of the plurality of comb-shaped stays; and
mounting a wire cake end ring and an end retaining ring on each of the plurality of comb-shaped stays.

8. The method for manufacturing the coil structure according to claim 7, wherein assembling the insulating cylindrical layer on the outer side of the inner coil comprises:
splicing two prefabricated inner semi-cylinders outside the inner coil to form an inner insulating cylinder;
winding at least one inner insulating layer on an outer wall of the inner insulating cylinder, and staggering a joint of the inner insulating layer and a joint of the inner insulating cylinder;
splicing two prefabricated outer semi-cylinders outside the inner insulating layer to form an outer insulating cylinder; and
winding at least one outer insulating layer on an outer wall of the outer insulating cylinder, and staggering a joint of the outer insulating layer and a joint of the outer insulating cylinder.

9. The method for manufacturing the coil structure according to claim 8, further comprising:
winding an insulating tape between the inner insulating layer and the outer insulating cylinder to form a second annular tape layer, and turning one end of the second annular tape layer outward so that a turned-out portion covers an end surface of the outer insulating cylinder to form a second corner ring.

10. The method for manufacturing the novel coil structure according to claim 7, wherein spacing apart the plurality of comb-shaped stays along the circumferential direction of the insulating cylindrical layer on the outer side of the insulating cylindrical layer, and wrapping and folding the insulating tape on the outer side of each of the plurality of comb-shaped stays to form the first corner ring comprises:
forming a first stay portion and a second stay portion in each of the plurality of comb-shaped stays, wherein a mounting groove is formed in the first stay portion, and the second stay portion is arranged in the mounting groove, and spaced apart from a groove wall of the mounting groove to form a corner ring slot;
spacing apart the first stay portion along the circumferential direction of the insulating cylindrical layer on the outer side of the insulating cylindrical layer;
winding a first limiting cylinder around each of the plurality of first stay portions;
wrapping the insulating tape around the first limiting cylinder to form a first annular tape layer;
winding a second limiting cylinder on an outer side of the first annular tape layer;
assembling a plurality of prefabricated arc-shaped rings on the outer side of the first annular tape layer to form a circular support ring, turning one end of the first annular tape layer outward and laying the turned-out portion on the support ring in a radial direction of the support ring to form a first corner ring; and
arranging the second stay portion in the corresponding first stay portion to form the corner ring slot, and clamping the first corner ring in the corner ring slot.

11. The coil structure according to claim 2, further comprising
a plurality of wire cake end rings, and
a second corner ring which comprises
a second cylinder, and
a second extension ring extending towards each of the plurality of comb-shaped stays to cover an end surface of each of the plurality of comb-shaped stays,
wherein one end of the second cylinder is connected to an inner ring of the second extension ring to form an included angle;
wherein the insulating cylinder layer comprises an inner insulating cylinder and an outer insulating cylinder that are in a sleeving manner;
wherein the inner coil is arranged around an inner side of the inner insulating cylinder, each of the plurality of comb-shaped stays is arranged on an outer side of the outer insulating cylinder; and
wherein the second cylinder is inserted between the inner insulating cylinder and the outer insulating cylinder.

12. The coil structure according to claim 2, further comprising a plurality of wire cake end rings and two end retaining rings,
wherein both ends of each of the plurality of comb-shaped stays respectively have a retaining ring slot which are farther away from each of the plurality of comb tooth notches than the two corner ring slots, and each of the two retaining ring slots is clamped to each of the two end retaining rings in a one-to-one correspondence manner.

13. The method for manufacturing the coil structure according to claim 10, wherein turning one end of the first annular tape layer outward and laying the turned-out portion on the support ring in a radial direction of the support ring to form a first corner ring further comprises:
turning outward one end of the first annular tape layer and laying the turned-out portion on the support ring in the radial direction of the support ring; and
stretching the turned-out portion to an outer ring of the support ring, and enabling the turned-out portion to cover the outer ring of the support ring to form the first corner ring.

14. The method for manufacturing the coil structure according to claim 7, wherein before winding the wire into the inner coil, the method further comprises: mounting a winding mold for supporting the wound inner coil on a core column of the core.

15. The method for manufacturing the coil structure according to claim 14, wherein after the wire cake end ring and the end retaining ring are mounted on each of the plurality of comb-shaped stays, the method further comprises:
removing the winding mold, and
performing varnish impregnation and drying on the wound coil structure.
